(19) United States
(12) Patent Application Publication
(10) Pub. No.: US 2006/0072643 A1
(43) Pub. Date: Apr. 6, 2006

(54) Pressure-thermometer in same time

(76) Inventor: Young Bin Kwon, Yang-chun gu (KR)

Correspondence Address: LADAS & PARRY LLP, 224 SOUTH MICHIGAN AVENUE, SUITE 1600, CHICAGO, IL, 60604, US

(21) Appl. No.: 10/535,971

(22) PCT Filed: Nov. 22, 2003
(86) PCT No.: PCT/KR03/02538

§ 371 Date: May 23, 2005

(30) Foreign Application Priority Data
Nov. 25, 2002 (KR) 20-2003-003511
Jun. 7, 2003 (KR) 20-2203-0018195
Oct. 30, 2003 (KR) 2003-007744443

(51) Int. Cl. G01K 1/14; G01K 1/00

(52) U.S. Cl. 374/143; 374/208

(57) ABSTRACT

The present invention relates to a pressure-thermometer in same time (thermometer combined with manometer) capable of achieving one combined meter in which a Bourdon tube manometer and a bimetal type thermometer are combined. A pressure scale and a temperature scale are separately formed on a character plate in a rectangular or circular casing. There is provided a separation type manometer-combined thermometer in which the centers of a pressure indication hand and a temperature indication hand are separated. There is provided an integration type manometer combined thermometer in which a pressure indication hand and a temperature indication hand are utilized together based on the same center. The above two constructions are achieved based on a dual shank and a dual movement.

### TECHNICAL FIELD

The present invention relates to a pressure-thermometer in same time (thermometer combined with manometer) capable of achieving one combined meter in which a Bourdon tube manometer and a bimetal type thermometer are combined. A pressure scale and a temperature scale are separately formed on a character plate in a rectangular or circular casing. There is provided a separation type manometer-combined thermometer in which the centers of a pressure indication hand and a temperature indication hand are separated. There is provided an integration type manometer combined thermometer in which a pressure indication hand and a temperature indication hand are utilized together based on the same center. The above two constructions are achieved based on a dual shank and a dual movement.

### BACKGROUND ART

Generally, the sizes of a capacity, speed, vibration, temperature, pressure, calorie and length or a physical state are detected based on a certain data (value) and are recorded and displayed using a certain measuring meter.

As a measuring meter capable of measuring a pressure of a fluid or gas or gravity, there are a mercury manometer having a certain weight and balance, a Bourdon tube manometer having an elastic force of an elastic member and a balance with respect to a dead weight manometer, and an electricity resistance manometer implemented using a physical phenomenon varying based on a diaphragm and a pressure.

Among the above manometers, the Bourdon tube manometer has been most widely used because it is possible to directly read the scales corresponding pressures, and it is easy to use the same.

In addition, as a thermometer generally used for an oxidation and spreading facility of a semiconductor fabrication process together with the above manometer, there are a thermal vibration thermometer capable of measuring temperature using an electromotive force generated by forming a closed circuit by connecting two kinds of metallic ends and changing the temperatures of both connection points, a mercury thermometer using a thermal expansion of mercury, and a temperature sensor implemented using thermoelectric couple widely used for the purpose of industry capable of measuring a temperature ranging from 400° C. to 1400° C.

However, in the above described thermometer and manometer, the thermometer and the manometer are separately installed. Therefore, an additional installation space is needed for both the thermometer and manometer. In addition, it is impossible to concurrently check the thermometer and the manometer because they are separately installed. The pressure and temperature of a fluid in a pipe should be concurrently measured. However, the pressure and temperature of the same are separately measured, so that an s error range is increased. There are many problems when maintaining the measuring units for thereby causing inconvenience during a measuring operation. There is a safety problem, so that workability is decreased.

### DISCLOSURE OF INVENTION

Accordingly, it is an object of the present invention to overcome the above conventional problems.

It is another object of the present invention to provide a combined measuring unit capable of concurrently measuring pressure and temperature wherein the temperature and pressure are concurrently measured at one point using one measuring unit. There is provided a dual shank connecting to different ways so that there is not any interference between pressure and temperature. Pressure and temperature indication hands are shared. A dual movement capable of precisely indicating values is used for thereby implementing a desired object of the present invention.

To achieve the above objects, there is provided a combined measuring unit capable of concurrently measuring pressure and temperature in which the pressure and temperature indication hands are implemented based on a separation type and an integration type because there is a difference in the inner structure and parts based on a method for indicating a pressure value and a temperature value.

To achieve the above objects, there is provided a separation type of a manometer combined thermometer comprising one casing in which pressure and temperature are measured. The thermometer includes a bimetal connected with a temperature indication hand 11, and a dual shank engaged to an upper outer side of a detection rod and capable of fixing a process chamber. The manometer includes a socket passing through a lower side of the dual shank of the thermometer and detecting a pressure of fluid and transferring a fluid pressure, a Bourdon tube attached to the socket and moved based on pressure, a dual movement capable of largely amplifying a small movement of the Bourdon in cooperation with the Bourdon tube, and a pressure indication hand indicating a pressure value on the indication plate in cooperation with the shaft of the dual movement.

The dual shank is a path capable of transferring a pressure and temperature of fluid to the measuring unit and is implemented based on a method that a hole is formed at the center of the dual shank, and a hole is formed in a thickness portion between the center hole and an outer screw for thereby implementing a compatibility operation using two holes for the pressure and temperature. There is another method that a temperature detection rod is, inserted into the center of the dual shank, and a hole is formed in a surrounding portion of the detection rod with a size of 1 mm between the outer portion of the detection rod and the inner wall of the dual shank, so that the circular hole surrounding the detection rod is used as a path of pressure fluid.

Therefore, in the separate type of the manometer combined thermometer according to the present invention, only the dual shank is used. The dual movement is not adapted. Namely, a common dual movement is adapted.

In the integration type of the manometer combined thermometer according to the present invention, the pressure and temperature values are implemented in one casing. In the thermometer, the detection rod having a bimetal passes through the center of the dual shank and contacts with fluid outside the dual shank.

At this time, the bimetal detects fluid temperature and is contracted and expanded. The above change is transferred to the shaft. The shaft passes through the inner diameter portion of the center gear shaft of the dual movement for thereby moving an indication hand connected to the end of the shaft, so that the temperature is indicated. The dual shank has a diameter larger than 1 mm as compared to the diameter of the temperature detection rod installed in the center portion, so that the gap of 1 mm between the detection rod and the wall of the dual shank is used as a path of the pressure fluid (type 1). A hole is formed in the center of the dual shank. A hole is formed between the center and the outer screw portion. Namely, two holes are totally formed. One hole is formed for the temperature detection rod, and the other hole is formed for the path of the pressure rod for thereby implementing compatibility.

The fluid passing in the above manner moves the pressure indication hand connected to an outer portion of the center gear of the dual movement for thereby indicating pressure.

Therefore, in the integration type of the manometer combined thermometer according present invention, the dual shank and the dual movement are adapted for thereby achieving a desired function.

### BRIEF DESCRIPTION OF DRAWINGS

The present invention will become better understood with reference to the accompanying drawings which are given only by way of illustration and thus are not limitative of the present invention, wherein;

FIG. 1 is a plane view illustrating a separation type of a manometer combined thermometer according to the present invention;

FIG. 2 is a plane view illustrating an integration type of a manometer combined thermometer according to the present invention;

FIG. 3 is a lateral view of FIG. 1;

FIG. 4 is a cut-away view of a type 1 of a dual shank;

FIG. 5 is a cut-away view of a type 2 of a dual shank;

FIG. 6 is a plane view of a dual movement;

FIG. 7 is a lateral view of FIG. 6; and

FIG. 8 is a view illustrating an inner structure of a separation type of a manometer combined thermometer according to the present invention.

### BEST MODE FOR CARRYING OUT THE INVENTION

The preferred embodiments of the present invention will be described with reference to the accompanying drawings.

1. Separation Type of Manometer Combined Thermometer

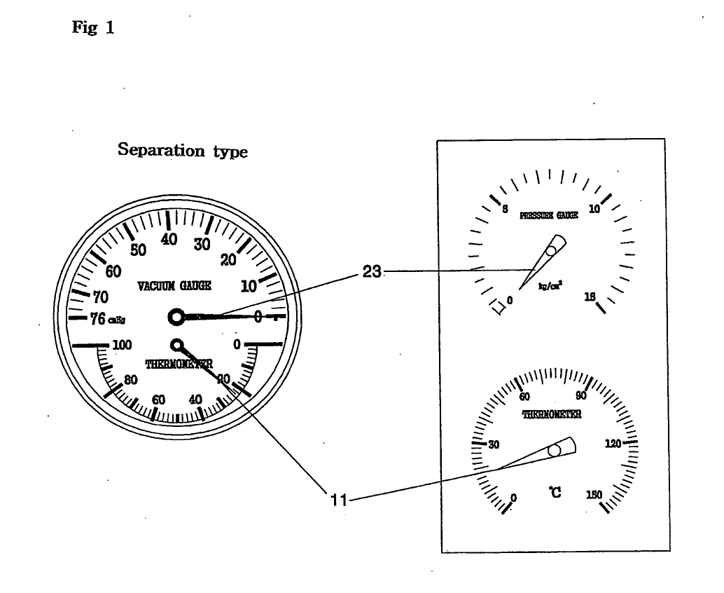

As shown in FIG. 1, in a circular or rectangular casing, a pressure scale is provided in an upper side of a character plate, and a temperature scale is provided in a lower side. The ranges of the pressure and temperature scales are 180° or 270°.

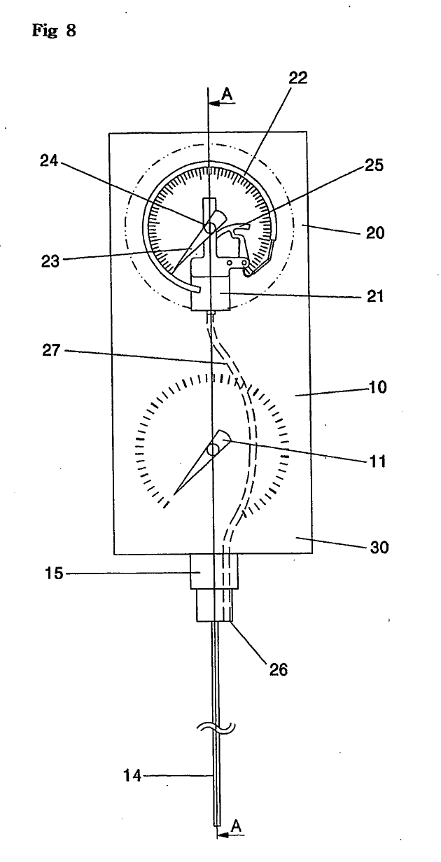

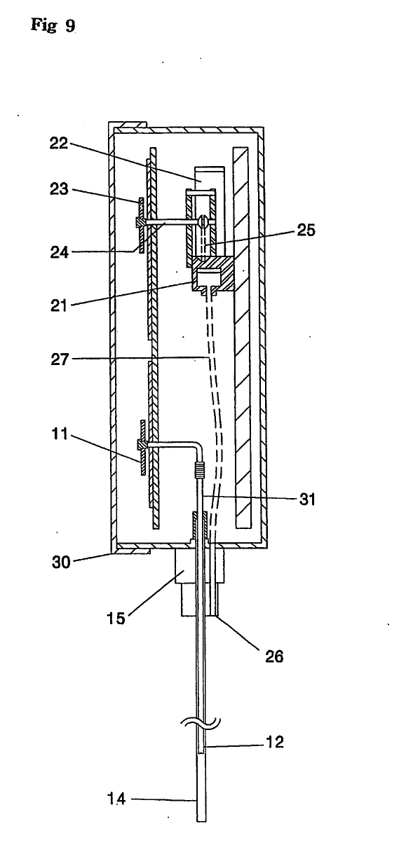

At this time, the dual shank is shown as an example with a reference numeral 15 of FIG. 8.

2. Integration Type of Manometer Combined Thermometer

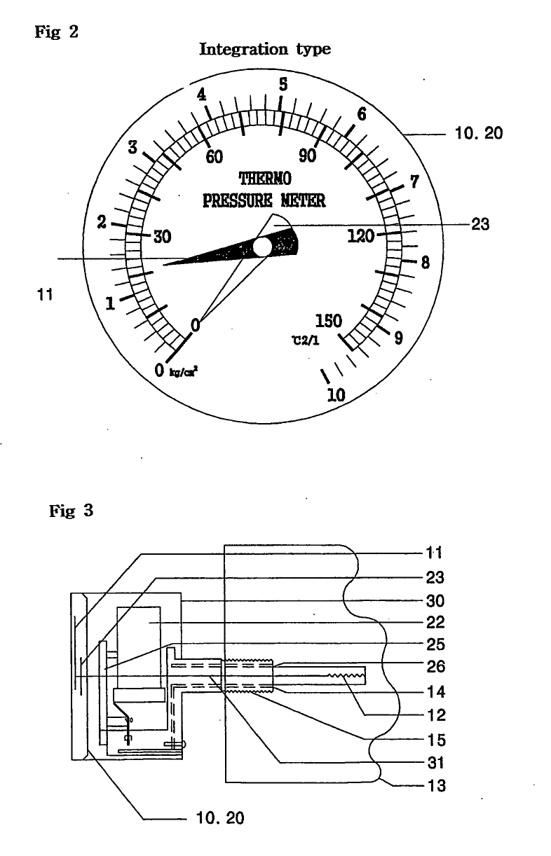

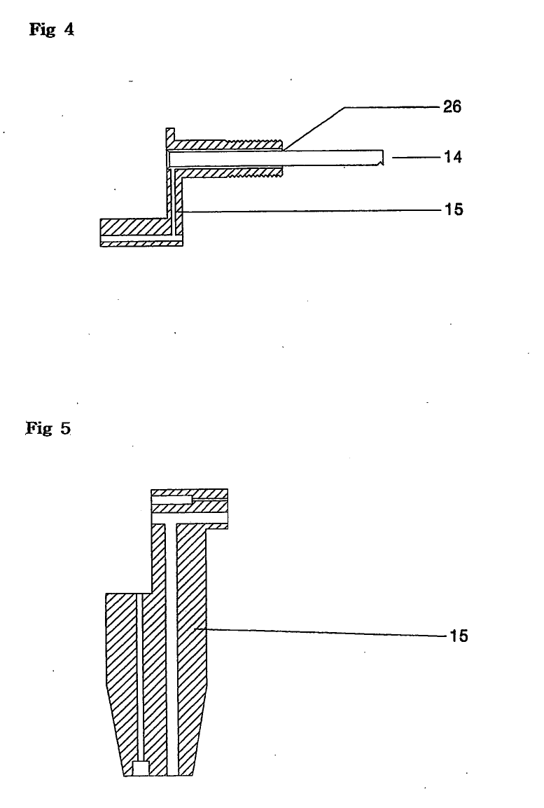

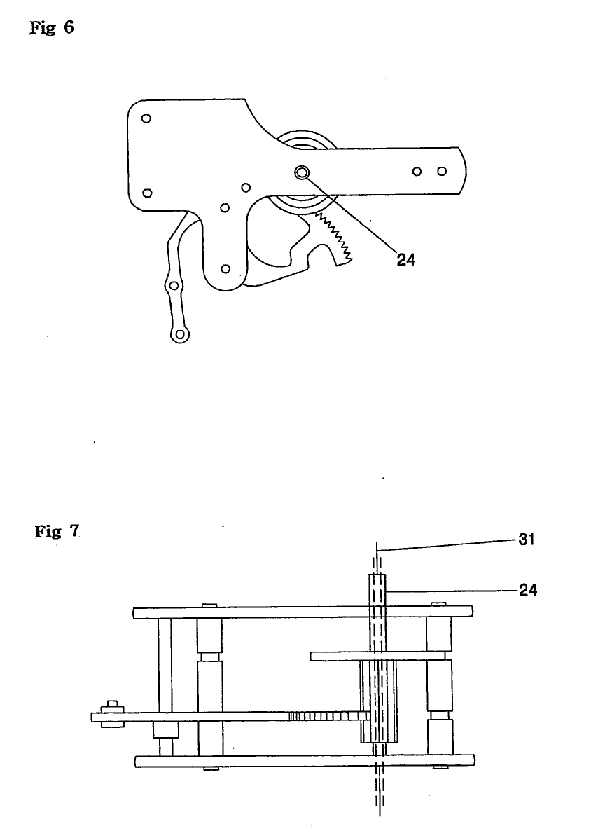

As shown in FIG. 2, the integration type uses a circular casing. A pressure scale is formed on the character plate, and a pressure scale is formed on the outer side of the character plate. The temperature scale is formed in the inner side. The indication hands of the pressure and temperature have the same sizes. The temperature scales and the temperature indication hands have the same colors, and the pressure scales and the pressure indication hands have the same colors, so that it is possible to easily recognize the pressure and temperature. In addition, there is a big brightness difference between the pressure and the temperature.

### INDUSTRIAL APPLICABILITY

The manometer combined thermometer according to the present invention is constructed in such a manner that the pressure of the fluid is applied in the dual shank, and at the same time the detection rod of the thermometer detects the surrounding temperature of the dual shank for thereby indicating temperature. The thusly measured pressure and temperature pass through the dual movement without any interference and obstacle and are transferred to the indication hands, so that pressure and temperature are indicated on the character plate. In the present invention, it is possible to easily concurrently measure the temperature and pressure at the same point with respect to fluid to be measured using one measuring unit. In the present invention, it is possible to overcome the problems of a space limit, two times increase of installation cost, an error of the fluid measuring value due to an upper position of the pressure and temperature measuring points. In addition, it is possible to obtain a driver's safety as compared to the measurements of the separately installed thermometer and manometer. It is possible to save work time of workers because the pressure and temperature are measured at one point, and energy is saved. The fabrication cost is decreased because the parts such as casing and shank are not needed. A cost required for workers is also decreased.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A manometer combined thermometer, comprising:
a casing in which a manometer and a thermometer are concurrently accommodated, wherein in the manometer a pressure of a fluid detected by an inlet 26 through a dual shank of a measuring unit passes through a Bourdon tube 22, and a dual movement 25 is moved in cooperation with a change of a Bourdon tube, and the values are indicated by a pressure indication hand 23, and in the thermometer, the temperature of the fluid in the interior of a process chamber 13 is indicated by moving a temperature indication hand 11 through a shaft 31 based on a change in a bimetal provided in the interior of the temperature detection rod 14; and wherein in the thermometer, the temperature is detected outside the temperature detection rod of the dual shank, and an inlet 26 into which a pressure fluid is flown is formed in the dual shank 15, and two holes for pressure and temperature are formed in the dual shank based on a method in which the manometer and the thermometer are installed in vertical and horizontal shapes; and wherein the dual shank is implemented based on a method (1) in which a hole of a temperature detection rod installed at the center is formed in the dual shank, and another hole of a pressure fluid is formed in a circle shape in the surrounding portion of the detection rod with a diameter of 1 mm, and a method (2) in which a hole is formed in the center of the dual shank, and another hole is formed between the center and an outer side of the shank, so that both holes are used for an inlet of the pressure fluid and an installation of the temperature detection rod.

2. A manometer combined thermometer, comprising:
a casing in which a manometer and a thermometer are concurrently accommodated, wherein in the manometer, a fluid pressure passing through a dual shank 15 and detected from an inlet 26 and cooperates with a dual movement based on a change of the Bourdon tube, and in the thermometer, a temperature is detected outside the temperature detection rod of the dual shank, and at the same time, is transferred to a shaft cooperating with the bimetal installed in the interior of the temperature detection rod, and the shaft passes through the dual shank and the hole passing through the interior of the center gear shaft 24 of the dual movement, so that a temperature indication hand engaged to an end of the same is operated, wherein the dual movement is capable of amplifying the pressure of the Bourdon tube of the manometer, and the outer side of the center gear shaft becomes a center of the pressure indication hands, and the bimetal shaft passes through the interior of the center gear shaft, and the outer side of the center shaft becomes a center of the temperature indication hands, wherein the dual movements of the above two functions are called a dual movement as a major element of the manometer and the thermometer.
